(19) United States
(12) Patent Application Publication
(10) Pub. No.: US 2003/0216978 A1
(43) Pub. Date: Nov. 20, 2003

(54) System and method for financial withholdings compliance

(76) Inventors: Steven L. Sweeney, Plano, TX (US); Frances L. Bartlett, Dallas, TX (US); Ronald Wong, Plano, TX (US); Connie L. Davis, Garland, TX (US)

Correspondence Address: DOCKET CLERK, P.O. DRAWER 800889, DALLAS, TX, 75380, US

(21) Appl. No.: 10/391,476

(22) Filed: Mar. 18, 2003

Related U.S. Application Data
(60) Provisional application No. 60/365,311, filed on Mar. 18, 2002.

(51) Int. Cl. G06F 17/60

(52) U.S. Cl. 705/30; 705/31

(57) ABSTRACT

A method includes receiving information identifying financial withholdings associated with an organization. The method also includes identifying a due date associated with the financial withholdings. In addition, the method includes facilitating a payment associated with the withholdings by the identified due date.

### RELATED APPLICATIONS

This application claims the benefit under 35 U.S.C. §119(e) of U.S. Application Serial No. 60/365,311 filed on Mar. 18, 2002.

### TECHNICAL FIELD OF THE INVENTION

This disclosure relates generally to database systems and more particularly to a system and method for financial withholdings compliance.

### BACKGROUND OF THE INVENTION

There are hundreds of millions of people in the work force in the United States and around the world. Many of these people typically receive paychecks once or more a month. Federal, state, and other tax revenues are often collected through automatic payroll deductions or other financial withholdings. These deductions usually appear to be automatic from the perspective of employees, but they often require significant resources on the part of the employers. For example, a company payroll department typically needs to make the appropriate withholdings and to disburse the withholdings to the appropriate government agencies or other tax collection authorities. Also, payroll tax regulations are one of the most complex and ever-changing areas of government regulation, and failure to comply with these regulations can result in significant penalties. As a result, employers are often required to expend significant resources to perform the tax withholding and other financial withholding operations.

### SUMMARY OF THE INVENTION

This disclosure provides an improved system and method for financial withholdings compliance.

In one embodiment, a method includes receiving information identifying financial withholdings associated with an organization. The method also includes identifying a due date associated with the financial withholdings. In addition, the method includes facilitating a payment associated with the withholdings by the identified due date.

One or more technical features may be present according to various embodiments of this disclosure. Particular embodiments of this disclosure may exhibit none, some, or all of the following features depending on the implementation. For example, in one embodiment, a system for financial withholdings compliance is provided. As a particular example, the system can be used to help manage the collection, depositing, and reporting of payroll or other taxes. At least some of the financial withholdings tasks can be automated, which may help to reduce the amount of resources that a company or other organization needs to expend in order to comply with government regulations. This may also help to reduce the likelihood that the organization will be penalized for failing to comply with those regulations. In addition, the compliance functionality can be distributed in any suitable manner, such as by being deployed over the Internet, over a private data network, or implemented on a single computer. This may allow a particular organization to distribute the compliance functionality in a manner that is suited for that organization.

This has outlined rather broadly several features of this disclosure so that those skilled in the art may better understand the detailed description that follows. Additional features may be described later in this document. Those skilled in the art should appreciate that they may readily use the concepts and the specific embodiments disclosed as a basis for modifying or designing other structures for carrying out the same purposes of this disclosure. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for other words and phrases are provided throughout this document, and those of ordinary skill in the art should understand that in many, if not most instances, such definitions apply to prior as well as future uses of such defined words and phrases.

### BRIEF DESCRIPTION OF THE DRAWINGS

For a more complete understanding of this disclosure, reference is made to the following descriptions taken in conjunction with the accompanying drawings, in which:

FIG. 1 is a block diagram illustrating an example system for financial withholdings compliance according to one embodiment of this disclosure;

FIG. 2 is a block diagram illustrating an example server facilitating financial withholdings compliance according to one embodiment of this disclosure;

FIG. 3 is a block diagram illustrating an example database facilitating financial withholdings compliance according to one embodiment of this disclosure;

FIG. 4 is a block diagram illustrating an example application model facilitating financial withholdings compliance according to one embodiment of this disclosure; and

FIG. 5 is a flow diagram illustrating an example method for financial withholdings compliance according to one embodiment of this disclosure.

### DETAILED DESCRIPTION OF THE INVENTION

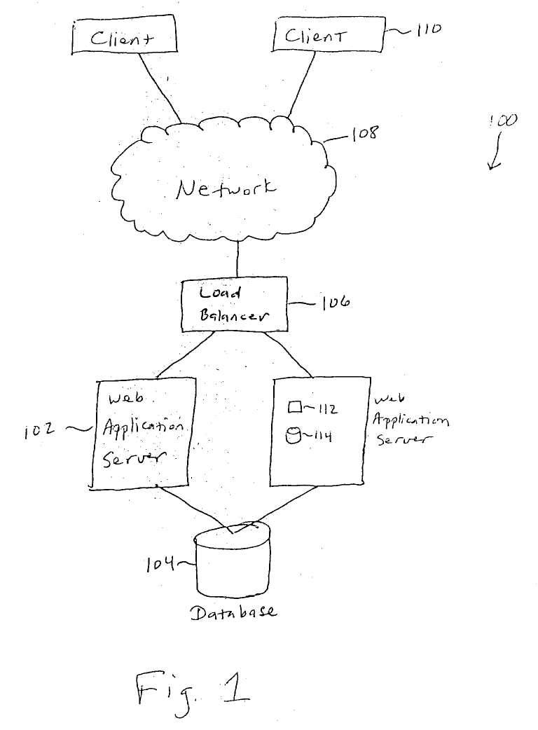

FIG. 1 is a block diagram illustrating an example system 100 for financial withholdings compliance according to one embodiment of this disclosure. In the illustrated example, the system 100 includes one or more servers 102, a database 104, a load balancer 106, a network 108, and one or more clients 110. This embodiment of the system 100 is for illustration only. Other embodiments may be used without departing from the scope of this disclosure.

In one aspect of operation, the servers 102 implement financial withholdings compliance functionality, which helps to facilitate compliance with government regulations. For example, the servers 102 could be used to facilitate compliance with payroll tax regulations or regulations regarding the reporting of mutual fund performance. As a particular example, the servers 102 could have access to tax calendars identifying when federal, state, and local payroll taxes are due. The servers 102 could then facilitate the printing of tax returns or the electronic payment of those taxes. In this way, the servers 102 can help to facilitate compliance with the payroll tax regulations. Also, by facilitating compliance with the regulations, the servers 102 may help to reduce or eliminate the likelihood that a penalty would be imposed on an individual or organization for failing to comply with the regulations.

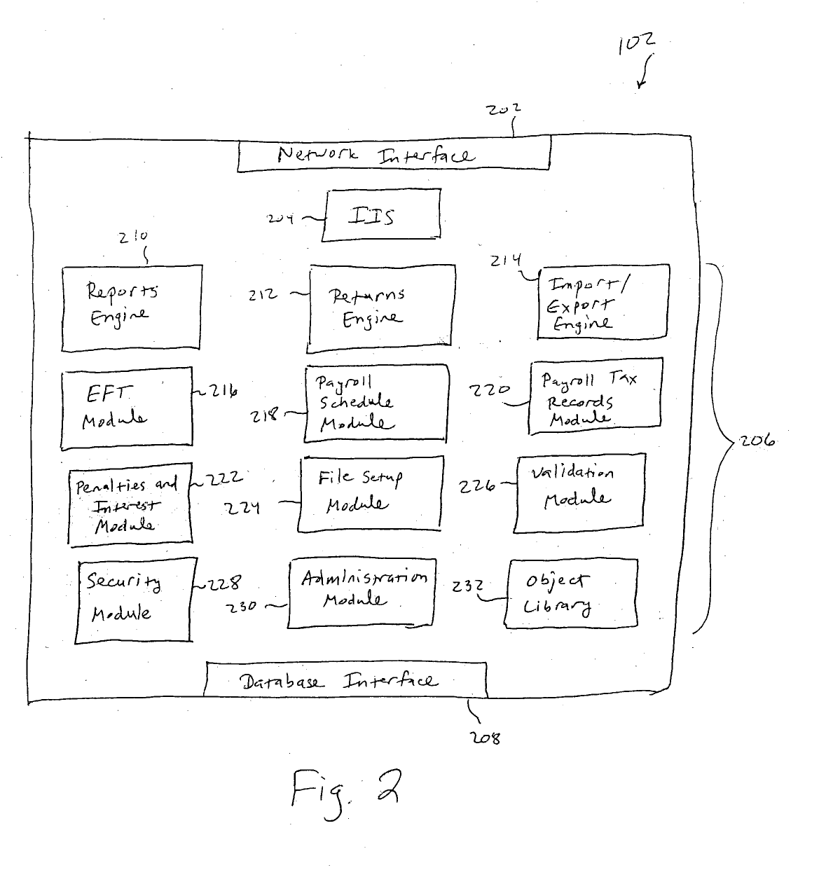

In the illustrated example, the servers 102 are coupled to the database 104 and the load balancer 106. In this document, the term “couple” refers to any direct or indirect communication between two or more components, whether or not those components are in physical contact with one another. Also, the term “communication” may refer to communication between physically separate components or between components within a single physical unit. The servers 102 implement the financial withholdings compliance functionality of the system 100. For example, the servers 102 may receive and store information identifying the payroll and other taxes that have been withheld from paychecks of the employees of an organization. The servers 102 may also monitor when the payroll and other taxes need to be sent to different government agencies or other collection authorities. The servers 102 may further support the payment of the payroll and other taxes, such as by printing tax returns and performing electronic filing and payment of the taxes. The servers 102 may include any hardware, software, firmware, or combination thereof that is operable to facilitate financial withholdings compliance. The servers 102 may, for example, include one or more processors 112 and one or more memories 114 operable to store data and instructions used by the processors 112. An example embodiment of a server 102 is shown in FIG. 2, which is described below.

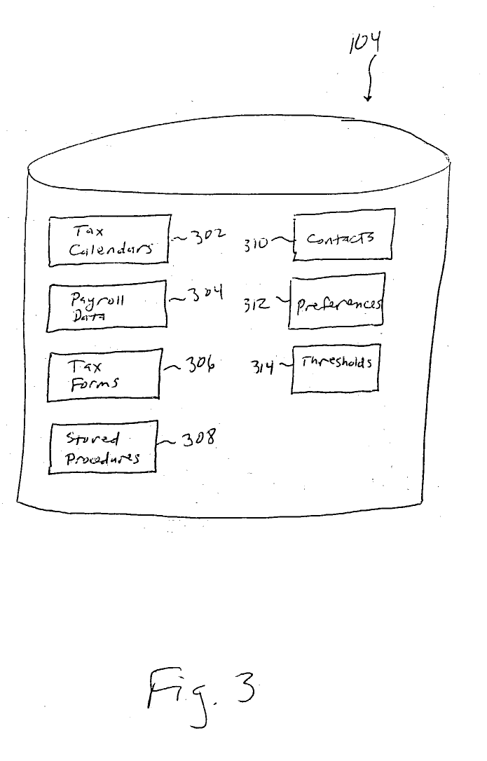

The database 104 is coupled to the servers 102. The database 104 stores and facilitates retrieval of information used by the servers 102. For example, the database 104 may store information identifying when payroll taxes are due and the payroll taxes that have been withheld from employees' paychecks. As a particular example, information about multiple organizations can be stored in the database 104, and the information may be indexed by the federal employer identification numbers associated with the organizations. The database 104 may include any hardware, software, firmware, or combination thereof that is operable to store and facilitate retrieval of information. The database 104 may also use any of a variety of data structures, arrangements, and compilations to store and facilitate retrieval of information. As particular examples, the database 104 could represent an Oracle or SQL database. An example embodiment of the database 104 is shown in FIG. 3, which is described below.

The load balancer 106 facilitates access to the servers 102. For example, the load balancer 106 may manage requests sent to the servers 102, such as by sending some requests to one server 102 and other requests to another server 102. In this way, the load balancer 106 may help to reduce the likelihood that one server 102 experiences too much traffic while the other server 102 has capacity to spare. The load balancer 106 could use any suitable load balancing technique. The load balancer 106 may include any hardware, software, firmware, or combination thereof that is operable to support load balancing of the servers 102.

The network 108 is coupled to the load balancer 106 and the clients 110. The network 108 facilitates communication between components of the system 100. For example, the network 108 may communicate Internet Protocol (IP) packets, frame relay frames, Asynchronous Transfer Mode (ATM) cells, or other suitable information between network addresses. The network 108 may include one or more local area networks (LANs), metropolitan area networks (MANs), wide area networks (WANs), all or a portion of a global network such as the Internet, or any other communication system or systems at one or more locations. The network 108 may also operate according to any appropriate type of protocol or protocols, such as Ethernet, IP, X.25, frame relay, or any other suitable protocol.

The clients 110 are coupled to the network 108. The clients 110 allow users to communicate with the servers 102 and invoke functions of the server 102. For example, the clients 110 could allow the user to request generation of payroll tax returns and to invoke electronic-payment of the payroll taxes. The clients 110 may include any hardware, software, firmware, or combination thereof that is operable to facilitate communication with the servers 102. As a particular example, the clients 110 could represent a desktop or other computing device executing a web browser, such as Microsoft Internet Explorer 6.0 or other suitable browsers.

Although FIG. 1 illustrates one example of a system 100 for financial withholdings compliance, various changes may be made to FIG. 1. For example, any number of servers 102 could be used in the system 100. Also, various components such as the load balancer 106 could be omitted, and other or additional components could be added to the system 100 according to particular needs. In addition, FIG. 1 illustrates the compliance functionality as residing on servers 102 that are accessible by clients 102. Other systems could be used to implement the compliance functionality. As particular examples, the compliance functionality could be implemented on a desktop computer, laptop computer, personal digital assistant, or other suitable device.

FIG. 2 is a block diagram illustrating an example server 102 facilitating financial withholdings compliance according to one embodiment of this disclosure. The server 102 illustrated in FIG. 2 is for illustration only. Other embodiments of the server 102 could be used without departing from the scope of this disclosure.

In the illustrated example, the server 102 includes a network interface 202, an Internet Information Server (IIS) module 204, one or more compliance modules 206, and a database interface 208. The network interface 202 allows the server 102 to be coupled to and communicate over the network 108. The network interface 202 may include any hardware, software, firmware, or combination thereof that is operable to facilitate communication over a network 108. For example, the network interface 202 could represent an Ethernet interface, such as a gigabit Ethernet interface.

The IIS module 204 acts as a web server to facilitate communication between the server 102 and clients 110 that use a web browser. For example, the IIS module 204 may facilitate the receipt of requests from the browser of a client 110. After the request is executed, the IIS module 204 can generate a Hypertext Markup Language (HTML) web page containing the results of the execution and communicate the web page for display at the client 110. The IIS module 204 could further encrypt and decrypt information communicated between the server 102 and the client 110 and create session objects associated with users that are logging onto the server 102. The IIS module 204 may include any hardware, software, firmware, or combination thereof that is operable to facilitate access to the server 102 using a web browser.

The compliance modules 206 represent different modules that implement the financial withholdings compliance functionality of the server 102. The functional division of the modules 206 is for illustration only. Various modules 206 can be combined or omitted and other or additional modules can be added according to particular needs. Each compliance module 206 could represent any hardware, software, firmware, or combination thereof. As a particular example, each module 206 could represent a software routine or routines executed by the server 102.

A reports engine 210 generates reports associated with the information stored in the database 104. For example, the reports engine 210 may generate reports identifying when payroll taxes are due, how much in payroll taxes are currently due, or previous payments of payroll taxes. In one embodiment, the reports engine 210 may include predefined reports and allow users to create customized reports. The predefined reports could represent reports that are often used by different organizations, while the customized reports could represent specialized reports for a particular organization. Any suitable reports can be generated by the reports engine 210. As a particular example, the reports engine 210 could generate wage detail reports listing employees and their salaries, which many states require for unemployment insurance purposes.

A returns engine 212 generates documents used to pay payroll and other taxes. For example, the returns engine 212 can generate federal, state, or local tax returns identifying the taxes owed by an organization. In one embodiment, each tax return is associated with a list of data or “attributes” needed to calculate the taxes, a set of functions used to retrieve this data from the database 104, and another set of functions used to process the retrieved data. When the returns engine 212 receives a request to generate a particular tax return, the returns engine 212 retrieves the appropriate data, processes that data, and inserts values into the tax return. The returns engine 212 then allows the user to view, edit, print, and save the tax return. In a particular embodiment, blank tax returns are stored as Portable Document Format (PDF) files in the database 104, and the returns engine 212 uses ActivePDF to dynamically generate completed tax returns. In this way, the user can see the prepared return on the display of the client 110, and the displayed return may look the same as it would after being printed.

An import/export engine 214 allows a user to import and export data into and out of the database 104. For example, the import function can be used to import new tax calendars identifying when taxes are due. The import function could also be used to import information identifying the payroll taxes that have been withheld from employees' recent paychecks. The export function can be used to retrieve specified data from the database 104 and generate a data file containing the retrieved data in a particular format. In this way, data from the system 100 can be provided to other systems, such as an accounts payable, accounting, or check-writing system. The export function could include predefined exports and customized exports. The predefined exports could represent exports that are often used by different organizations, and the customized exports could represent specialized exports for a particular organization.

An electronic funds transfer (EFT) module 216 supports the ability to electronically pay the payroll and other taxes. For example, the EFT module 216 may allow an organization to deposit payroll taxes in the appropriate government agency's account. In a particular embodiment, different federal, state, and local agencies may require different payment formats, and the EFT module 216 could support some or all of those different payment formats. In a particular embodiment, the EFT module 216 may allow electronic filing to occur without the use of a modem, such as by supporting payments using a File Transfer Protocol (FTP) or Hypertext Transfer Protocol (HTTP). By allowing an organization to make electronic payments of taxes, the organization can keep the payments as long as possible, helping the organization to earn more interest on the payments.

A payroll schedule module 218 allows a user to schedule payroll processing and pay date schedules. For example, the server 102 may include functionality for processing payroll data to identify how much is owed in payroll taxes, and the payroll schedule module 218 allows the user to specify when this processing occurs. Also, the date on which employees are paid can be controlled by adjusting the pay date schedule using the payroll schedule module 218.

A payroll tax records module 220 allows a user to create and maintain a history of the payroll tax records stored in the database 104. The payroll tax records module 220 also allows the user to control tax due date calculations and to identify due date thresholds. In one embodiment, certain government regulations may specify: a default date when a tax would ordinarily be due and certain conditions that change the due date. As a particular example, federal regulations may state that payroll taxes are due quarterly unless more than $100,000 is owed, in which case the taxes are due on the next business day. The payroll tax records module 220 allows the user to control these thresholds.

A penalties and interest module 222 allows a user to track and pay any penalties and interest imposed by government agencies or other collection authorities. For example, despite the use of the compliance functionality, an organization may end up paying a tax late. In this case, the user can provide the penalties and interest module 222 with the penalty and any interest that needs to be paid by the organization. The penalties and interest module 222 can then track when the penalty and interest are due and facilitate automatic payment of the penalty and interest.

A file setup module 224 allows the user to set up various parameters used by the server 102 to facilitate financial withholdings compliance. For example, the file setup module 224 may allow the user to identify business units in an organization using the server 102 and bank and checking accounts used to pay taxes. The file setup module 224 could also allow the user to identify agencies to which taxes need to be paid, addresses of processing centers that process the tax payments, and tax rates.

A validation module 226 allows a user to track the taxes that have been paid. For example, the user can import information identifying the payroll taxes that have been paid, and the validation module 226 can mark those taxes as paid. The user could also manually mark taxes as having been paid.

A security module 228 allows users to create and modify security parameters of the server 102. For example, an administrator could create a security role, which contains a group of rules that define the rights and privileges of users assigned to that role. Any number of security roles could be used in the system 100. The administrator could also use the security module 228 to create user accounts for new users of the server 102.

An administration module 230 allows a user to maintain settings and activate modules 206 for specific organizations. For example, multiple organizations may use the server 102, and those organizations may wish to use different modules 206. As a specific example, one organization could represent a business that needs to pay payroll taxes, so the business may need access to the returns engine 212. Another organization could represent a mutual fund company that uses the server 102 to facilitate the reporting of mutual fund performance, so this organization may not need access to the returns engine 212.

An object library 232 stores objects that implement various functions of the server 102. For example, the objects could implement functions to retrieve data from the database 104. In a particular embodiment, the objects are divided into tiers. For example, a presentation layer could contain objects used to interface with users, such as by handling requests from clients 110 and generating HTML web pages used to display information to and collect information from a client 110. A data layer could contain objects that facilitate access to data and stored procedures in the database 104. A business layer could contain objects that facilitate interaction between the presentation layer and the data layer. The business layer could also implement business rules and enforce business-specified options. In a particular embodiment, the objects in the object library 232 represent Microsoft COM+ objects generated using Visual Basic.

Database interface 208 allows the server 102 to be coupled to and communicate with the database 104. The database interface 208 may include any hardware, software, firmware, or combination thereof that is operable to facilitate communication between the server 102 and the database 104.

Although FIG. 2 illustrates one example of a server 102 facilitating financial withholdings compliance, various changes may be made to FIG. 2. For example, the components illustrated in the server 102 are for illustration only. Various components can be combined or omitted and other or additional components could be added according to particular needs. As a particular example, one or more modules 210-230 could be implemented as objects in the object library 232.,

FIG. 3 is a block diagram illustrating an example database 104 facilitating financial withholdings compliance according to one embodiment of this disclosure. The database 104 illustrated in FIG. 3 is for illustration only. Other embodiments of the database 104 could be used without departing from the scope of this disclosure.

In the illustrated example, the database 104 includes tax calendars 302. The tax calendars 302 identify due dates for various taxes that might be owed by an organization. For example, the tax calendars 302 could identify actual dates on which taxes are due or formulas used to calculate when taxes are due. As particular examples, multiple tax calendars 302 could be provided identifying due dates for different federal, state, and local taxes.

Payroll data 304 represents data about payroll taxes that have been or will be withheld from employees' paychecks. For example, the payroll data 304 may include information identifying the amount of payroll taxes previously withheld and the dates on which the payroll taxes were withheld. Instead of or in addition to payroll data 304, other types of financial withholding information may be stored in the database 104, such as data relating to mutual fund performance.

Tax forms 306 represent blank forms and other documents used to pay taxes to government agencies or other collecting authorities. For example, the tax forms 306 could represent forms used to file annual, quarterly, monthly, or other taxes. In one embodiment, the tax forms 306 represent PDF files. The forms 306 could represent any other documents as well, such as forms needed for unemployment insurance purposes.

Stored procedures 308 represent one or more procedures that process data in the database 104. For example, in one embodiment, some of the logic that processes data may reside in the servers 102, such as in the object library 232. If the function to be performed requires that the server 102 repeatedly access the database 104, it may be more efficient to create a stored procedure 308, which can be executed more efficiently at the database 104. Any suitable stored procedure 308 can be used and stored in the database 104. Also, in other embodiments, stored procedures 308 need not be used in the database 104.

Contacts 310 represent contact information associated with an organization. For example, the contacts 310 could represent personnel within an organization or associated with an organization, personnel at a government agency or other tax collecting authority, or any other suitable contact. The information in the contacts 310 may include names, addresses, telephone numbers, electronic mail addresses, or any other or additional information.

Preferences 312 represent preferences of a user or organization. For example, a preference 312 could control how information is displayed to a user. A preference 312 could also indicate that an organization wishes to automatically pay a tax if less than a specified amount but that approval is required if the tax is greater than the specified amount. Any other or additional preferences 312 could be used in the system 100.

Thresholds 314 are used to expedite payment of taxes when certain conditions are met. As described above, government regulations may specify a default date when a tax would be due and conditions that change the due date. The thresholds 314 represent the various conditions under which tax due dates may change. Any other or additional thresholds can be used in the system 100.

Although FIG. 3 illustrates one example of a database 104 facilitating financial withholdings compliance, various changes may be made to FIG. 3. For example, the information illustrated in the database 104 is for illustration only. Various information can be combined or omitted and other or additional information could be stored according to particular needs. Also, while FIG. 3 illustrates a single database 104 storing the information, any number of databases 104 could be used.

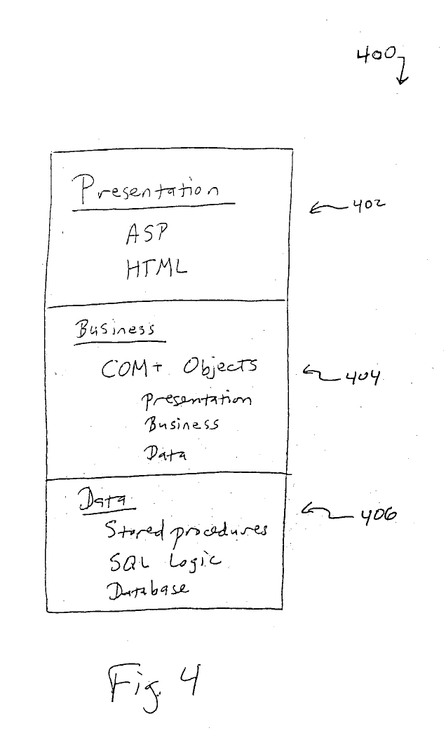

FIG. 4 is a block diagram illustrating an example application model 400 facilitating financial withholdings compliance according to one embodiment of this disclosure. The application model 400 may be implemented in the system 100 of FIG. 1. The application model 400 is for illustration only. Any other application model can be used in any suitable system without departing from the scope of this disclosure.

In the illustrated example, the application model 400 includes a presentation layer 402, a business layer 404, and a data layer 406. In a particular embodiment, the presentation layer 402, business layer 404, and data layer 406 correspond to the client 110, server 102, and database 104, respectively.

The presentation layer 402 facilitates communication with a user using a client 110. In the illustrated example, the presentation layer 402 uses Application Server Pages (ASP) and HTML to support communication with the user. This may allow, for example, HTML web pages to be viewed by the user and used to facilitate communication with the server 102.

The business layer 404 supports communication between the other layers 402, 406 and the execution of business and other rules. In the illustrated example, the business layer 404 uses COM+ objects, which may be stored in the object library 232 of the server 102. As explained above, the objects in the object library 232 may also be divided into presentation, business, and data layer objects.

The data layer 406 supports access to the database 104. For example, the data layer 406 includes logic to access and use stored procedures, as well as SQL logic used to access tables in the database. The data layer 406 also provides a physical interface to facilitate communication with the database 104.

Although FIG. 4 illustrates one example of an application model 400 facilitating financial withholdings compliance, various changes may be made to FIG. 4. For example, other objects can be used in place of the COM+ objects in the business layer 404. Also, any other or additional layers can be used and supported in the system 100 or any other suitable system.

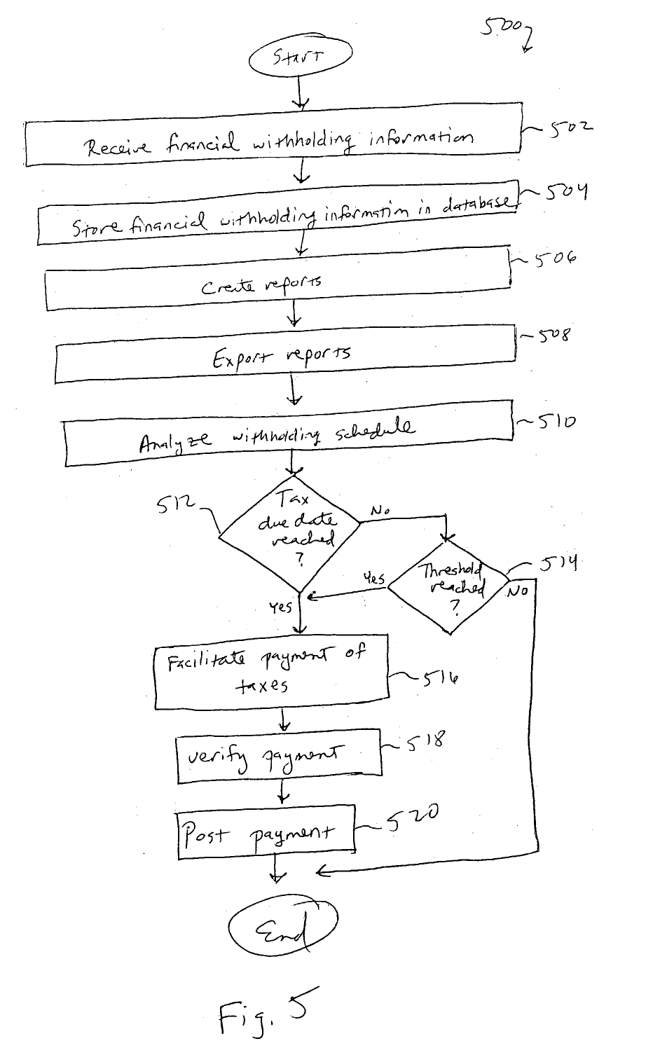

FIG. 5 is a flow diagram illustrating an example method 500 for financial withholdings compliance according to one embodiment of this disclosure. While the method 500 may be described with respect to the system 100 of FIG. 1, the method 500 could be used in any other suitable system.

The server 102 receives financial withholding information at step 502. This may include, for example, the server 102 receiving the amount of payroll taxes that have been withheld from employees' paychecks and the date of the withholding. As a particular example, this may include a user importing the financial withholding information using the import/export engine 214. The server 102 stores the financial withholding information at step 504. This may include, for example, the server 102 storing the financial withholding information in the database 104 as payroll data 304.

The server 102 creates one or more reports at step 506. This may include, for example, the user submitting a request and the reports engine 210 retrieving the required data and generating a report. The server 102 exports the report at step 508. This may include, for example, the import/export engine 214 exporting the generated report to a location specified by the user. As a particular example, the report could be exported to another financial system.

The server 102 analyzes a withholdings schedule at step 510. This may include, for example, the server 102 examining the tax calendars 302 to determine when particular taxes are due. The server 102 determines whether a tax due date has been reached at step 512. This may include, for example, the server 102 determining whether a final due date for a tax has been reached using the tax calendars 302. This may also include a user specifying that taxes should be paid a certain number of days before the final due date.

If a user-specified or other due date has been reached, the server 102 facilitates payment of the tax at step 516. This may include, for example, the returns engine 212 generating one or more tax documents, such as tax returns. In particular, this may include the returns engine 212 retrieving one or more tax forms 306, calculating the values to be inserted into the tax forms 306, and generating a completed tax form containing the values. The tax return can then be mailed to a government agency. The step of facilitating the tax payment could further include generating an electronic tax return and making an electronic payment to the government agency using the EFT module 216.

The tax payment is verified at step 518. This may include, for example, the EFT module 216 verifying that the payment was received by the government agency. In addition, the server 102 posts the payment of the tax at step 520. This may include, for example, the user validating the payment using the validation module 226 or the server 102 automatically marking the tax as having been paid.

If no due dates have been reached at step 512, the server 102 also determines whether one or more thresholds have been reached at step 514. This may include, for example, the server 102 accessing the thresholds 314 in the database 104 and determining whether any of the thresholds have been met. If any of the thresholds have been met, the server 102 again facilitates the payment of the taxes at step 516, verifies the payment at step 518, and posts the payment at step 520.

Although FIG. 5 illustrates one example of a method 500 for financial withholdings compliance, various changes may be made to FIG. 5. For example, the user need not generate reports at step 506 or export the reports at step 508. Also, the server 102 could determine whether any thresholds have been met before determining whether any due dates have been reached.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
receiving information identifying financial withholdings associated with an organization;
identifying a due date associated with the financial withholdings; and
facilitating a payment associated with the withholdings by the identified due date.

2. The method of claim 1, wherein identifying the due date comprises:
accessing at least one tax calendar associated with at least one of a federal, state, and local tax; and
identifying the due date using the at least one tax calendar.

3. The method of claim 1, wherein identifying the due date comprises:
identifying a default due date; and
determining if a threshold has been met, the threshold identifying one or more conditions that change the identified default due date.

4. The method of claim 1, wherein facilitating the payment comprises:
generating a tax return; and
printing the tax return.

5. The method of claim 4, wherein generating the tax return comprises:
retrieving a blank tax return;
generating one or more values using at least a portion of the information identifying the withholdings; and
inserting the one or more generated values into the blank tax return to generate a completed tax return.

6. The method of claim 5, wherein generating the one or more values comprises:
identifying one or more data fields associated with the one or more values;
using a first set of functions to retrieve data from the identified data fields; and
using a second set of functions to generate the one or more values using the retrieved data.

7. The method of claim 1, wherein facilitating the payment comprises:
generating an electronic tax return; and
making an electronic payment of the withholdings.

8. The method of claim 1, further comprising generating at least one report using at least a portion of the information identifying the withholdings.

9. The method of claim 1, further comprising:
receiving information identifying at least one of a penalty and interest owed due to a late payment; and
facilitating a second payment of the at least one penalty and interest.

10. The method of claim 1, wherein the financial withholdings comprise payroll tax withholdings associated with employees of the organization.

11. A system, comprising:
a memory operable to store information identifying financial withholdings associated with an organization; and
one or more processors collectively operable to:
identify a due date associated with the financial withholdings; and
facilitate a payment associated with the withholdings by the identified due date.

12. The system of claim 11, wherein the one or more processors are collectively operable to identify the due date by:
accessing at least one tax calendar associated with at least one of a federal, state, and local tax; and
identifying the due date using the at least one tax calendar.

13. The system of claim 11, wherein the one or more processors are collectively operable to identify the due date by:
identifying a default due date; and
determining if a threshold has been met, the threshold identifying one or more conditions that change the identified default due date.

14. The system of claim 11, wherein the one or more processors are collectively operable to facilitate the payment by at least one of:
generating and printing a tax return; and
generating an electronic tax return and making an electronic payment of the withholdings.

15. The system of claim 14, wherein the one or more processors are collectively operable to generate the tax return by:
retrieving a blank tax return;
generating one or more values using at least a portion of the information identifying the withholdings; and
inserting the one or more generated values into the blank tax return to generate a completed tax return.

16. The system of claim 15, wherein the one or more processors are collectively operable to generate the one or more values by:
identifying one or more data fields associated with the one or more values;
using a first set of functions to retrieve data from the identified data fields; and
using a second set of functions to generate the one or more values using the retrieved data.

17. The system of claim 11, wherein the one or more processors are further collectively operable to:
receive information identifying at least one of a penalty and interest owed due to a late payment; and
facilitate a second payment of the at least one penalty and interest.

18. A method, comprising:
communicating information identifying financial withholdings associated with an organization for storage;
receiving an indication of a due date associated with the financial withholdings; and
initiating a payment associated with the withholdings by the identified due date.

19. The method of claim 18, wherein communicating the information for storage comprises communicating information identifying amounts and dates of payroll tax withholdings to a server for storage in a database.

20. The method of claim 18, wherein initiating a payment comprises at least one of:
initiating generation and printing of a tax return; and
initiating generation and electronic filing of an electronic tax return.
